(19) United States
(12) Patent Application Publication
(10) Pub. No.: US 2005/0011409 A1
(43) Pub. Date: Jan. 20, 2005

(54) Inorganic oxide

(76) Inventor: Yasuhide Isobe, Shizuoka (JP)

Correspondence Address: BIRCH STEWART KOLASCH & BIRCH, PO BOX 747, FALLS CHURCH, VA, 22040-0747, US

(21) Appl. No.: 10/499,981

(22) PCT Filed: Dec. 12, 2002
(86) PCT No.: PCT/JP02/13449

(30) Foreign Application Priority Data
Dec. 25, 2001 (JP) 2001-391214

(51) Int. Cl. C04B 14/04

(52) U.S. Cl. 106/490

(57) ABSTRACT

An object of the present invention is to provide a powder capable of easily being re-dispersed into an inorganic oxide substantially not aggregated even after the inorganic oxide having a small particle diameter is dried. The invention relates to a powder obtained by treating a hydrous dispersion of an inorganic oxide having an average particle diameter measured by a dynamic light scattering method, D₁, of 3 nm to 1 μm, with a silane coupling agent followed by drying, wherein the powder has an average particle diameter at the time when re-dispersed in a dispersing medium, D₂, satisfying the following formula (1):
1≦D₂/D₁≦2 (1)

### TECHNICAL FIELD

The present invention relates to a fine particulate inorganic oxide and a powder of an inorganic oxide capable of easily being re-dispersed.

### BACKGROUND ART

Inorganic oxide particles (secondary particles) formed by aggregation of numerous inorganic oxide fine particles (primary particles) are already known. For example, JP 56-120511 A discloses a porous powder having a substantially uniform pore size comprising aggregates of spherical particles having an aluminosilicate coating and, as a method for producing the same, a process for producing a porous powder comprising drying an aluminosilicate aqueous sol containing particles having a uniform size without gelation to form a powder. However, these conventional inorganic oxide particles (secondary particles), including those in the above publication, could not be re-dispersed to inorganic oxide fine particles (primary particles) which constitute the secondary particles.

Inorganic oxide particles (secondary particles) capable of being re-dispersed to inorganic oxide fine particles (primary particles) have been shown in JP 08-067505 A, but this required special drying such as spray drying, baking at a high temperature, and ultrasonic treatment over a period of several tens of minutes. Moreover, dispersion could not be effected according to this technique in the case of inorganic oxide fine particles (primary particles) having a size of 100 nm or less.

In addition, those disclosed in JP 05-008047 B are known as a re-dispersible silica dispersion, but the particle diameter is as large as from 1 to 20 μm, and also the degree of re-dispersion is only to an extent that formation of dense precipitates is prevented. JP O₂-001090 B discloses a powdery silica capable of being dispersed homogeneously in an organic solvent and composed of silica particles at a colloidal state, but the silica were not re-dispersed unless the water content of the solvent of the silica sol was reduced to 10% by weight or less. Furthermore, it is not re-dispersed in a solvent containing water.

Shikizai, 55 (9) 630-636, 1982, discloses a powder wherein an Aerosil powder dispersed in deionized ion-exchange water is treated with a silane coupling agent containing an amino group. For the purpose of measuring the surface charge of the powder, the treated powder is dispersed in deionized water. However, since a supernatant is formed, most of the aggregated particles are not re-dispersed.

The invention provides a powder capable of easily being re-dispersed to an inorganic oxide that is substantially not aggregated even after the inorganic oxide having a small particle diameter is dried.

### DISCLOSURE OF THE INVENTION

Namely, the present invention relates to the following:
(1) A powder obtained by treating a hydrous dispersion of an inorganic oxide having an average particle diameter measured by a dynamic light scattering method, D₁, of 3 nm to 1 μm, with a silane coupling agent followed by drying, wherein the powder has an average particle diameter at the time when re-dispersed in a dispersing medium, D₂, satisfying the following formula (1):
   1≦D₂/D₁≦2 (1)
(2) The powder according to the above (1), wherein the inorganic oxide is synthesized using an aqueous solvent.
(3) The powder according to the above (1) or (2), wherein the inorganic oxide is a porous material.
(4) The powder according to any one of the above (1) to (3), wherein the inorganic oxide has a uniform pore diameter, an average particle diameter of the particles measured by a dynamic light scattering method, D_{L}, of 10 to 400 nm, and a difference between a converted specific surface area S_{L} determined from D_{L} and a nitrogen-absorption specific surface area SB of the particles by the BET method, S_{B}-S_{L}, is 250 m²/g or more.
(5) The powder according to any one of the above (1) to (4), wherein the inorganic oxide is silicon oxide.
(6) The powder according to any one of the above (1) to (5), wherein the silane coupling agent contains a quaternary ammonium salt and/or an amino group.
(7) A process for producing the powder according to any one of the above (1) to (6), comprising steps of treating a hydrous dispersion of an inorganic oxide with a silane coupling agent, followed by drying the dispersion.
(8) The process for producing the powder according to the above (7), wherein the drying step is carried out according to at least any one of drying by heating, vacuum drying, and supercritical drying.
(9) A dispersing process comprising a step of dispersing a powder in a dispersing medium, wherein the powder is the powder according to any one of the above (1) to (6) and an ultrasonic wave is used in the dispersing step.
(10) A dispersing process comprising a step of dispersing a powder in a dispersing medium, wherein the powder is the powder according to any one of the above (1) to (6) and the dispersion is adjusted to have a pH of 5 or lower or 9 or higher in the dispersing step.

### BEST MODE FOR CARRYING OUT THE INVENTION

The present invention is described in more detail below.

The average particle diameter of the inorganic oxide of the invention measured by a dynamic light scattering method is preferably from 3 nm to 1 μm, more preferably from 3 to 300 nm, further preferably from 3 to 200 nm. When the inorganic oxide is dispersed in a dispersing medium or a binder, a more transparent product is obtained, provided the particle diameter is 200 nm or less. In particular, when it is used as an ink-absorbing layer of an ink-jet recording medium, printed matter having good color-developing property and a high color density is obtained due to the high transparency. When the diameter is larger than 200 nm, transparency decreases, and when the diameter is larger than 1 μm, the particles tend to precipitate. Thus, the case is not preferred depending on the applications.

In the invention, the dispersing medium to be used for the hydrous dispersion of the inorganic oxide may be any as long as it contains water in an amount of 20% by weight or more and causes no precipitation. Preferably, a mixed solvent of water and one or two or more solvent selected from alcohols is employed. For the alcohols, lower alcohols such as ethanol and methanol are preferred.

In the invention, drying of the dispersion of the inorganic oxide may be carried out by any method as long as the method can remove the dispersing medium. However, methods such as drying by heating, vacuum drying, and supercritical drying are preferred, and from the viewpoint of convenience only, drying by heating is more preferred. The temperature is preferably 40° C. or higher, more preferably from 40° C. to 100° C.

In the invention, it is a characteristic that the inorganic oxide before and after drying satisfies the following formula (1), wherein D₁ is an average particle diameter of the inorganic oxide before it is treated with a silane coupling agent and D₂ is an average particle size at the time when re-dispersed in a dispersing medium after drying. The average particle diameter is measured by a dynamic light scattering method. As the dispersing medium in measuring D₂, water, ethanol, or toluene is employed. It is sufficient to satisfy the formula (1) for at least one medium of these dispersing media.
1≦D₂/D₁≦2 (1)

The case that D₂/D₁ is 1 means that re-dispersibility is extremely satisfactory. On the other hand, the case that D₂/D₁ exceeds 2 means that re-dispersibility is bad and a desired effect is not obtained even when the inorganic oxide is applied to uses, e.g., various additives such as deodorants and film fillers, cosmetics, pigments, paints, fillers for plastics, etc.

In the invention, the inorganic oxide is not particularly limited and includes oxides of silicon, alkaline earth metals such as magnesium and calcium and zinc belonging to the Group 2, aluminum, gallium, rare earths and the like belonging to the Group 3, titanium, zirconium and the like belonging to the Group 4, phosphorus and vanadium belonging to the Group 5, manganese, tellurium and the like belonging to the Group 7, and iron, cobalt and the like belonging to the Group 8. In particular, use of silica-based inorganic fine particles is useful.

For the inorganic oxides in the invention, some were synthesized using an aqueous solvent (solvent containing water in an amount of 20% by weight or more). The inorganic oxides synthesized in an aqueous solvent frequently have a number of hydroxyl groups on the particles, and when they are dried without any treatment, the hydroxyl groups react with each other. Hence, the inorganic oxides are not re-dispersed in a dispersing medium. According to the present invention, inorganic oxides, which could have been hitherto handled only in a dispersed state in a solvent, can be handled as a powder. Therefore, the powder of the invention is excellent in handling property, transporting costs, and stability as well as a dispersion having a desired concentration can be easily prepared. A colloidal silica such as SNOWTEX manufactured by Nissan Chemical Industries, Ltd is an example of the inorganic oxide.

Moreover, when the inorganic oxide is a porous material, it has a higher number of hydroxyl groups, and hence, the effect becomes enormous. As an example of the porous material, there is a material prepared by a production process comprising a step of mixing a metal source comprising a metal oxide and/or its precursor with a template and water to produce a sol of a metal oxide/template complex and a step of removing the template from the complex. A porous material as shown in WO 02-00550 is an example.

In particular, it is preferred to have inorganic oxides with a uniform fine pore diameter, an average particle diameter of the particles measured by a dynamic light scattering method, D_{L}, of 10 to 400 nm, and a difference between a converted specific surface area SL determined from D_{L} and a nitrogen-absorption specific surface area S_{B} of the particles by the BET method, S_{B}-S_{L}, is 250 m²/g or more. These inorganic oxides are described in more detail below.

The inorganic oxide having a uniform pore diameter means an inorganic oxide wherein 50% or more of the total pore volume is included in the range of ±50% of the average pore diameter, with the pore diameter and total pore volume (volume of fine pores having a pore diameter of 50 nm or less measurable by a nitrogen absorption method) determined by a nitrogen absorption isothermal curve. Moreover, it is possible to confirm that the fine pores are uniform by a TEM observation.

The converted specific surface area S_{L} (m²/g) calculated from the average particle diameter D_{L} (nm) measured by a dynamic light scattering method is determined in accordance with an equation: S_{L}=6×10³/(density (g/cm³)×D_{L}), assuming that the particles of a porous substance are spherical. The fact that the difference between the value and the nitrogen-absorption specific surface area S_{B} by the BET method, S_{B}-S_{L}, is 250 m²/g or more means that particles of a porous substance are highly porous. When the value is small, the ability to absorb substances inside the substance decreases, and hence, the ink-absorbing amount decreases in the case that the particles are used as an ink-absorbing layer, for example. The S_{B}-S_{L} is preferably 1500 m²/g or less. When the value is large, the handling property sometimes becomes worse.

In the invention, the inorganic oxide is treated with a silane coupling agent. When the inorganic oxide contains a hydroxyl group, the silane coupling agent reacts with the hydroxyl group to decrease the reactivity of the inorganic oxide particles themselves, whereby it becomes easy to disperse the particles. Moreover, acidification or addition of a cationic substance or an organic solvent also facilitates stable dispersion.

The silane coupling agent to be used is preferably a compound represented by the following general formula (2):
XₙSi (OR)₄₋ₙ (2)
wherein X represents a hydrocarbon group having 1 to 12 carbon atoms, a hydrocarbon group having 1 to 12 carbon atoms which is substituted by a quaternary ammonium group and/or an amino group, or a group where hydrocarbon groups having 1 to 12 carbon atoms which may be substituted by a quaternary ammonium group and/or an amino group are linked with one or more nitrogen atoms, R represents a hydrogen atom or a hydrocarbon group having 1 to 12 carbon atoms, and n is an integer of 1 to 3.

Specific examples of R include a methyl group, an ethyl group, a propyl group, an isopropyl group, a butyl group, an isobutyl group, a tert-butyl group, a pentyl group, an isopentyl group, a neopentyl group, a hexyl group, an isohexyl group, a cyclohexyl group, a benzyl group, and the like. Alkyl groups having 1 to 3 carbon atoms are preferred, and a methyl group and an ethyl group are most preferred.

Moreover, among the groups of X, specific examples of the hydrocarbon group having 1 to 12 carbon atoms include a methyl group, an ethyl group, a propyl group, an isopropyl group, a butyl group, an isobutyl group, a cyclohexyl group, a benzyl group, and the like. A methyl group, an ethyl group, a propyl group, a butyl group, a cyclohexyl group, and a benzyl group are preferred.

Furthermore, among the groups of X, specific examples of the hydrocarbon group having 1 to 12 carbon atoms which is substituted by a quaternary ammonium group and/or an amino group include an aminomethyl group, an aminoethyl group, an aminopropyl group, an aminoisopropyl group, an aminobutyl group, an aminoisobutyl group, an aminocyclohexyl group, an aminobenzyl group, and the like. An aminoethyl group, an aminopropyl group, an aminocyclohexyl group, and an aminobenzyl group are preferred.

In addition, among the groups of X, the hydrocarbon group having 1 to 12 carbon atoms in the group where hydrocarbon groups having 1 to 12 carbon atoms which may be substituted by a quaternary ammonium group and/or an amino group are linked with one or two or more nitrogen atoms is the same as above. The number of nitrogen atom(s) linking the hydrocarbon groups which may be substituted by a quaternary ammonium group and/or an amino group is preferably from 1 to 4.

Specific examples of the compound represented by the above general formula (2) include methyltriethoxysilane, butyltrimethoxysilane, dimethyldimethoxysilane, aminopropyltrimethoxysilane, (aminoethyl)aminopropyltrimethoxysilane, aminopropyltriethoxysilane, aminopropyldimethylethoxysilane, aminopropylmethyldiethoxysilane, aminobutyltriethoxysilane, 3-(N-stearylmethyl-2-aminoethylamino)-propyltrimethoxysilane hydrochloride, aminoethylaminomethylphenethyltrimethoxysilane, 3-[2-(2-aminoethylaminoethylamino)propyl]trimethoxysilane, and the like.

The amount of the silane coupling agent is preferably from 0.002 to 2, more preferably from 0.01 to 0.7 in terms of the weight ratio of the silane coupling agent to the inorganic oxide. When the silane coupling agent contains a nitrogen atom, the weight ratio of the nitrogen atom in the dry weight of the inorganic oxide after treatment (hereinafter, referred to as content) is preferably from 0.1 to 10%, more preferably from 0.3 to 6%. When the content is too low, it is sometimes difficult to obtain the advantages of the invention. When the content exceeds 10%, the product sometimes lacks workability and other aptitudes for industrialization.

For the method of treatment with the silane coupling agent, the agent may be directly added to a hydrous dispersion of the inorganic oxide. Alternatively, the agent may be added after being dispersed in an organic solvent beforehand and hydrolyzed in the presence of water and a catalyst. For the treating conditions, it is preferred to conduct the treatment at a temperature of room temperature to the boiling point of the hydrous dispersion for several minutes to several days, more preferably at a temperature of 25° C. to 55° C. for 2 minutes to 5 hours.

The organic solvent could be alcohols, ketones, ethers, esters, and the like. More specific examples thereof to be used include alcohols such as methanol, ethanol, propanol, and butanol, ketones such as methyl ethyl ketone and methyl isobutyl ketone, glycol ethers such as methyl cellosolve, ethyl cellosolve, and propylene glycol monopropyl ether, glycols such as ethylene glycol, propylene glycol, and hexylene glycol, esters such as methyl acetate, ethyl acetate, methyl lactate, and ethyl lactate. The amount of the organic solvent is not particularly limited, but the weight ratio of the organic solvent to the silane coupling agent is preferably from 1 to 500, more preferably from 5 to 50.

For the catalyst, an inorganic acid such as hydrochloric acid, nitric acid, or sulfuric acid, an organic acid such as acetic acid, oxalic acid, or toluenesulfonic acid, or a compound showing a basicity, such as ammonia, an amine, or an alkali metal hydroxide can be used.

The amount of water necessary for the hydrolysis of the above silane coupling agent is desirably from 0.5 to 50 mol, preferably from 1 to 25 mol per mol of Si-OR group which constitutes the silane coupling agent. The catalyst is desirably added so as to be from 0.01 to 1 mol, preferably from 0.05 to 0.8 mol per mol of the silane coupling agent.

The hydrolysis of the above silane coupling agent is conducted usually under an ordinary pressure at the temperature of the boiling point of the solvent used or lower, preferably at a temperature about 5 to 10° C. lower than the boiling point. When a heat-resistant pressure vessel such as an autoclave is employed, it can be conducted at a temperature higher than the above-mentioned temperature.

In the invention, the method for re-dispersing a dispersion of an inorganic oxide after it is dried can be stirring by a stirrer or methods using a dispersing machine utilizing an ultrasonic wave, a ball mill, a high-pressure dispersing machine, and the like. It is preferred to employ an ultrasonic wave from the viewpoint that dispersion can be effected within a short period, e.g., about 1 minute and the particle structure of the inorganic oxide can be maintained. The dispersing medium is suitably selected depending on intended uses of the dispersion of the inorganic oxide of the invention but preferably, one solvent selected from water and alcohols or a mixed solvent of two or more of them is used. For the alcohols, lower alcohols such as ethanol and methanol are preferred. In the case that the silane coupling agent contains a quaternary ammonium salt and/or an amino group, the dispersion is preferably adjusted to have a pH of 5 or lower or 9 or higher in order to enlarge the absolute value of the surface charge of the inorganic oxide treated with the silane coupling agent.

### EXAMPLES

The present invention will be illustrated in greater detail with reference to the following Examples.

The average particle diameter according to a dynamic light scattering method was measured by a laser zeta-potential electrometer ELS-800 manufactured by Otsuka Electronics Co., Ltd.

The pore distribution and specific surface area were measured with nitrogen using AUTOSORB-1 manufactured by Quantachrome. The pore distribution was calculated by the BJH method. The average pore diameter was calculated from the values of peaks in the mesopore region of a differential pore distribution curve determined by the BJH method. The specific surface area was calculated by the BET method.

### Example 1

To 100 g of a silica sol having an average particle diameter of 15 nm adjusted to a solid mass concentration of 20% by weight (ST-N manufactured by Nissan Chemical Industries, Ltd.) was added 2.9 g of 3-(2-aminoethyl)aminopropyltrimethoxysilane. After the mixture was thoroughly stirred, 6N hydrochloric acid was added thereto under stirring until the pH reached 2.1. The resulting sol was dried by heating at 80° C. to obtain a powder. To 7.5 g of the resulting powder was added 42.5 g of distilled water, and the powder was dispersed for 1 minute using an ultrasonic dispersing machine to thereby obtain a transparent sol. The pH was 2.5, the average particle diameter after re-dispersion was 15 nm, and D₂/D₁ was 1.0.

### Example 2

To 100 g of a silica sol having an average particle diameter of 15 nm adjusted to a solid mass concentration of 20% by weight (ST-N manufactured by Nissan Chemical Industries, Ltd.) was added 2.9 g of 3-(2-aminoethyl)aminopropyltrimethoxysilane. After thoroughly stirred, the mixture was dried by heating at 80° C. to obtain a powder. To 7.5 g of the resulting powder was added 42.5 g of distilled water, and then 6N nitric acid was added thereto under stirring until the pH reached 3.8. The powder was dispersed for 1 minute using an ultrasonic dispersing machine to thereby obtain a transparent sol. The pH was 3.9, the average particle diameter after re-dispersion was 15 nm, and D₂/D₁ was 1.0.

### Example 3

To 200 g of a pearl necklace-like silica sol having an average particle diameter of 140 nm adjusted to a solid mass concentration of 13% by weight (ST-PSSO manufactured by Nissan Chemical Industries, Ltd.) was added 1.8 g of 3-(2-aminoethyl)aminopropyltrimethoxysilane. After the mixture was thoroughly stirred, 6N hydrochloric acid was added thereto under stirring until the pH reached 2.3. The resulting sol was dried by heating at 80° C. to obtain a powder. To 14.5 g of the resulting powder was added 33.8 g of distilled water, and the powder was dispersed for 1 minute using an ultrasonic dispersing machine to thereby obtain a transparent sol. The pH was 3.0, the average particle diameter after re-dispersion was 155 nm, and D₂/D₁ was 1.1.

### Example 4

To 200 g of a pearl necklace-like silica sol having an average particle diameter of 140 nm adjusted to a solid mass concentration of 13% by weight (ST-PSSO manufactured by Nissan Chemical Industries, Ltd.) was added 3.6 g of 3-(2-aminoethyl)aminopropyltrimethoxysilane. After the mixture was thoroughly stirred, 6N hydrochloric acid was added thereto under stirring until the pH reached 2.4. The resulting sol was dried by heating at 80° C. to obtain a powder. To 14.5 g of the resulting powder was added 33.8 g of distilled water, and the powder was dispersed for 1 minute using an ultrasonic dispersing machine to thereby obtain a transparent sol. The pH was 3.1, the average particle diameter after re-dispersion was 150 nm, and D₂/D₁ was 1.1.

### Example 5

Into a dispersion of 1000 g of a cation-exchange resin (Amberlite, IR-120B) converted to H^{d+}-type beforehand in 1000 g of water was added a solution of 333.3 g of water glass No. 3 (SiO₂=29% by weight, Na₂O=9.5% by weight) diluted with 666.7 g of water. After the mixture was thoroughly stirred, the cation-exchange resin was filtered off to obtain 2000 g of an active silica aqueous solution. The SiO₂ concentration of the active silica aqueous solution was 5.0% by weight.

In 8700 g of water was dissolved 100 g of Pluronic P103 manufactured by Asahi Denka Co., Ltd., and 1200 g of the above active silica aqueous solution was added thereto under stirring in a warm water bath at 35° C. The pH of the mixture was 4.0. At this time, the weight ratio of water/P103 was 98.4 and the weight ratio of P103/SiO₂ was 1.67. After the mixture was stirred at 35° C. for 15 minutes, it was allowed to stand at 95° C. and the reaction was effected for 24 hours. A predetermined amount of ethanol was added to the solution and P103 was removed using an ultrafiltration apparatus to obtain a transparent inorganic oxide sol (A) having an SiO₂ concentration of 8.2% by weight.

The average particle diameter of the sample in the sol (A) measured by a dynamic light scattering method was 200 nm and the converted specific surface area was 13.6 m²/g. The sol was dried at 105° C. to obtain an inorganic oxide. The average pore diameter of the sample was 10 nm and the pore volume was 1.11 ml/g. The nitrogen-absorption specific surface area by the BET method was 540 m²/g, and the difference from the converted specific surface area was 526.4 m²/g.

To 100 g of the sol (A) was added 0.6 g of 3-(2-aminoethyl)aminopropyltrimethoxysilane. After the mixture was thoroughly stirred, 6N hydrochloric acid was added thereto under stirring until the pH reached 2.1. The resulting sol was dried by heating at 80° C. to obtain a powder. To 4.3 g of the resulting powder was added 28.5 g of distilled water, and the powder was dispersed for 1 minute using an ultrasonic dispersing machine to thereby obtain a transparent sol. The pH was 2.6, the average particle diameter after re-dispersion was 220 nm, and D₂/D₁ was 1.1.

### Example 6

Into a dispersion of 300 g of a cation-exchange resin (Amberlite, IR-120B) converted to H⁺-type beforehand in 300 g of water was added a solution of 100 g of water glass No. 3 (SiO₂=30% by weight, Na₂O=9.5% by weight) diluted with 200 g of water. After the mixture was thoroughly stirred, the cation-exchange resin was filtered off to obtain 600 g of an active silica aqueous solution. The SiO₂ concentration of the solution was 5% by weight. The solution was diluted with 1675 g of purified water. Separately, 500 g of an aqueous solution in which 50 g of Pluronic P103 was dissolved, 200 g of 0.015 mol/l of a sodium hydroxide aqueous solution, and 25 g of trimethylbenzene were mixed, and the mixture was heated under stirring at 60° C. for 1 hour to obtain a white transparent solution. After the solution was added dropwise to the diluted active silica aqueous solution and the whole was mixed, the mixture was heated at 80° C. for 24 hours. A predetermined amount of ethanol was added to the solution, and P103 was removed using an ultrafiltration apparatus to obtain an inorganic oxide sol (B) having an SiO₂ concentration of 8.5% by weight.

The average particle diameter of the sample in the sol (B) was measured by a dynamic light scattering method and was found to be 195 nm, and the converted specific surface area was 15 m²/g. The solution was dried at 105° C. to obtain an inorganic oxide. The average pore diameter was 18 nm and the pore volume was 1.67 ml/g. The nitrogen-absorption specific surface area by the BET method was 413 m²/g and the difference from the converted specific surface area was 398 m²/g.

To 100 g of the sol (B) were added 80 g of ethanol and 2.4 g of 3-(2-aminoethyl)aminopropyltrimethoxysilane. After the mixture was thoroughly stirred, 6N hydrochloric acid was added thereto under stirring until the pH reached 2.5. The resulting sol was dried by heating at 70° C. to obtain a powder. To 2.5 g of the resulting powder was added 47.5 g of distilled water, and the powder was dispersed for 1 minute using an ultrasonic dispersing machine to thereby obtain a transparent sol. The pH was 2.5, the average particle diameter after re-dispersion was 230 nm, and D₂/D₁ was 1.2.

### Comparative Example 1

Except that the operation of adding 3-(2-aminoethyl)aminopropyltrimethoxysilane was omitted in Example 1, Example 1 was repeated in the same manner. Although 42.5 g of distilled water was added to 7.5 g of the resulting powder and the powder was dispersed for 1 minute using an ultrasonic dispersing machine, no sol was obtained. The average particle diameter was 990 nm and D₂/D₁ was 66.0.

### Comparative Example 2

Except that the operation of adding 3-(2-aminoethyl)aminopropyltrimethoxysilane was omitted in Example 6, Example 6 was repeated in the same manner. Although 28.5 g of distilled water was added to 4.3 g of the resulting powder and the powder was dispersed for 1 minute using an ultrasonic dispersing machine, no sol was obtained. The average particle diameter was 1800 nm and thus D₂/D₁ was 9.0.

While the invention has been described in detail and with reference to specific examples thereof, it will be apparent to one skilled in the art that various changes and modifications can be made therein without departing from the spirit and scope thereof.

The present application is based on Japanese Patent Application No. 2001-391214 filed on Dec. 25, 2001, and the contents thereof are incorporated herein by reference.

### INDUSTRIAL APPLICABILITY

The inorganic oxide powder of the present invention is extremely satisfactory in re-dispersibility and hence is suitable for uses as, e.g., various additives such as deodorants and film fillers, cosmetics, pigments, paints, fillers for plastics, etc.

Moreover, since inorganic oxides which could have been hitherto handled only as a dispersed state in a solvent can be handled as a powder, the powder is excellent in a handling property, transporting costs, and stability and enables easy preparation of a dispersion having a desired concentration.

1. A powder obtained by treating a hydrous dispersion of an inorganic oxide having an average particle diameter measured by a dynamic light scattering method, D₁, of 3 nm to 1 μm, with a silane coupling agent, followed by drying, wherein the powder has an average particle diameter at the time when re-dispersed in a dispersing medium, D₂, satisfying the following formula (1):
1≦D₂/D₁≦2 (1)

2. The powder according to claim 1, wherein the inorganic oxide is synthesized using an aqueous solvent.

3. The powder according to claim 1 or 2, wherein the inorganic oxide is a porous material.

4. The powder according to claim 1 or 2, wherein the inorganic oxide has a uniform pore diameter, an average particle diameter of the particles measured by a dynamic light scattering method, D_{L}, of from 10 to 400 nm, and a difference between a converted specific surface area S_{L} determined from D_{L} and a nitrogen-absorption specific surface area S_{B} of the particles by the BET method, SB-SL, is 250 m²/g or more.

5. The powder according to claim 1 or 2, wherein the inorganic oxide is silicone oxide.

6. The powder according to claim 1 or 2, wherein the silane coupling agent contains a quaternary ammonium salt and/or an amino group.

7. A process for producing the powder according to claim 1 or 2, comprising steps of treating a hydrous dispersion of an inorganic oxide with a silane coupling agent, followed by drying.

8. The process for producing the powder according to claim 7, wherein the drying step is carried out according to at least any one of drying by heating, vacuum drying, and supercritical drying.

9. A dispersing process comprising a step of dispersing a powder in a dispersing medium, wherein the powder is the powder according to claim 1 or 2 and an ultrasonic wave is used in the dispersing step.

10. A dispersing process comprising a step of dispersing a powder in a dispersing medium, wherein the powder is the powder according to claim 1 or 2 and the dispersion is adjusted to have a pH of 5 or lower or 9 or higher in the dispersing step.
